(19) United States
(12) Patent Application Publication
(10) Pub. No.: US 2023/0302623 A1
(43) Pub. Date: Sep. 28, 2023

(54) HAND-HELD TOOL STOCK ADAPTER

(71) Applicants: Eston John Hoffman, Berrysburg, PA (US); David A. Henninger, Berrysburg, PA (US)

(72) Inventors: Eston John Hoffman, Berrysburg, PA (US); David A. Henninger, Berrysburg, PA (US)

(21) Appl. No.: 18/125,674

(22) Filed: Mar. 23, 2023

Related U.S. Application Data
(60) Provisional application No. 63/269,789, filed on Mar. 23, 2022.

(51) Int. Cl. B25F 5/02

(52) U.S. Cl. CPC B25F 5/026

(57) ABSTRACT

A tool adapter provides an extended stock that can be attached to a hand-held tool, allowing additional force and stabilization input from a user. The adapter may have a stock extending beyond the length of the tool and a body that engages the tool. At least one strap fixes the adapter to the tool. The adapter is removable and can be used on a variety of tools of varying sizes.

### CROSS-REFERENCE TO RELATED APPLICATIONS

This application claims the benefit under 35 U.S.C. § 119 of U.S. Provisional Application Serial No. 63/269,789, filed on Mar. 23, 2022, which is incorporated herein by reference.

### STATEMENT REGARDING FEDERALLY SPONSORED RESEARCH

Not applicable.

### BACKGROUND OF THE INVENTION

The present disclosure generally relates to an adapter for a hand-held tool. More specifically, the disclosure relates to an adapter comprising an extended stock that permits a user to apply additional force or leverage to a tool during use.

Hand-held tools are ubiquitous in construction, manufacturing, automotive, and other industries. While the small size of hand-held tools is useful for jobs that demand mobile solutions, the drawback is that a user’s hands are primarily responsible for supplying the forces necessary to engage and stabilize the tool. In addition to the fatigue experienced by a user in applying the forces for engagement of the tool, the vibrations caused by the tool are felt directly in the user’s hands and can cause overuse injuries. Stationary tools can be built larger and minimize the vibrations and forces experienced by a user. For example, a stationary drill press is less demanding on the user than a hand-held tool. However, a drill press can not be moved around a job site with ease. Therefore, it would be advantageous to develop an adapter that can be removably attached to a hand-held tool, where the adapter allows the user to engage other body parts to leverage and stabilize the tool.

### BRIEF SUMMARY

According to embodiments of the present disclosure is an adapter comprising a body and an extended stock. In one embodiment, the stock extends from the rear of a hand-held tool and is shaped to engage the crook of a user’s shoulder. The stock, similar to a stock found on a rifle, provides a third point of contact in addition to the user’s two hands. By using their shoulder, a user can minimize the fatigue experienced in their hands as the user can leverage their weight into the tool through the stock. In one example embodiment, the adapter further comprises a pair of straps that encircle the tool to provide stability to the adapter when it is fitted to the tool. The straps can be made of removable restraints, such as hook-and-loop fasteners. As such, when the job does not demand higher forces from the user or the tool must be used in a tight workspace, the adapter can be easily removed.

### BRIEF DESCRIPTION OF THE SEVERAL VIEWS OF THE DRAWINGS

FIGS. 1A-1B shows the adapter according to one embodiment.

FIGS. 2A-2B show the adapter fitted to a variety of hand-held tools.

FIG. 3 shows an adapter with an adjustable length stock.

FIG. 4 depicts the adapter with a strap in an alternate location.

FIGS. 5A-5C show the adapter in various stages of installation.

FIG. 6 is an alternative embodiment of the adapter.

FIG. 7 is yet another alternative embodiment of the adapter.

FIG. 8 is yet another alternative embodiment of the adapter for use with an off-the-shelf stock.

FIG. 9 is yet another alternative embodiment of the adapter for use with an fixed stock.

### DETAILED DESCRIPTION

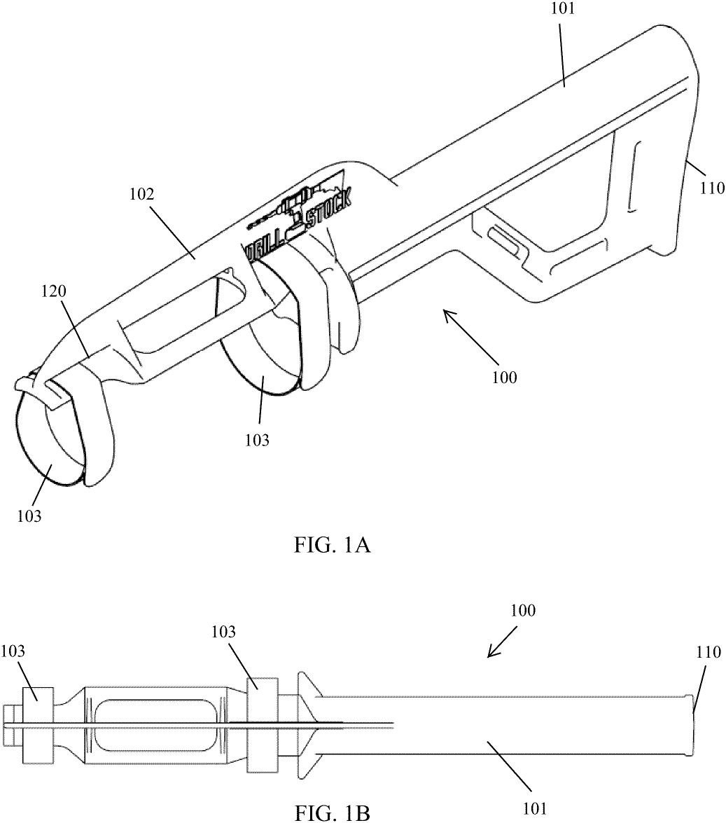

According to embodiments of the disclosure is an adapter 100 that can be fitted to a hand-held tool 200, such as a drill, impact driver, impact wrench, hammer drill, rotary hammer, and similar tools. The tool 200 may be battery-powered, pneumatic, or corded. As shown in FIGS. 1A-1B, the adapter comprises an extended stock 101, a body 102, and at least one strap 103. FIG. 1A and FIG. 1B are perspective and top profile views of the adapter 100, respectively. The stock 101 has a length extending from the body 102 at a proximate end near the end of the tool 200 to a shoulder rest 110 at a distal end. The stock 101 may extend generally along the longitudinal axis of the body 102. In one embodiment, the stock 101 extends from the body 102, forming a monolithic component as shown in FIG. 1. Alternatively, the extended stock 101 may removably attach to the rear of the body 102. With a removable interface, off-the-shelf stocks 101 used in the firearm industry can be fitted to the adapter 100. Typically, off-the-shelf stocks 101 utilize a screw mechanism, meaning the body 102 will have a screw fitting to accept the stock 101. However, other interface mechanisms may be used.

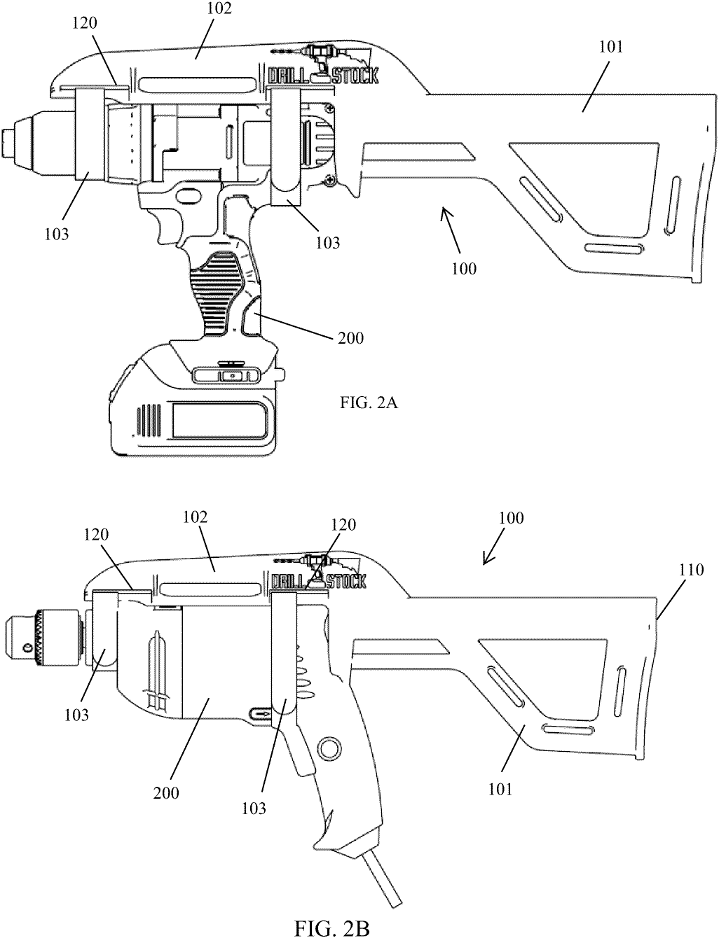

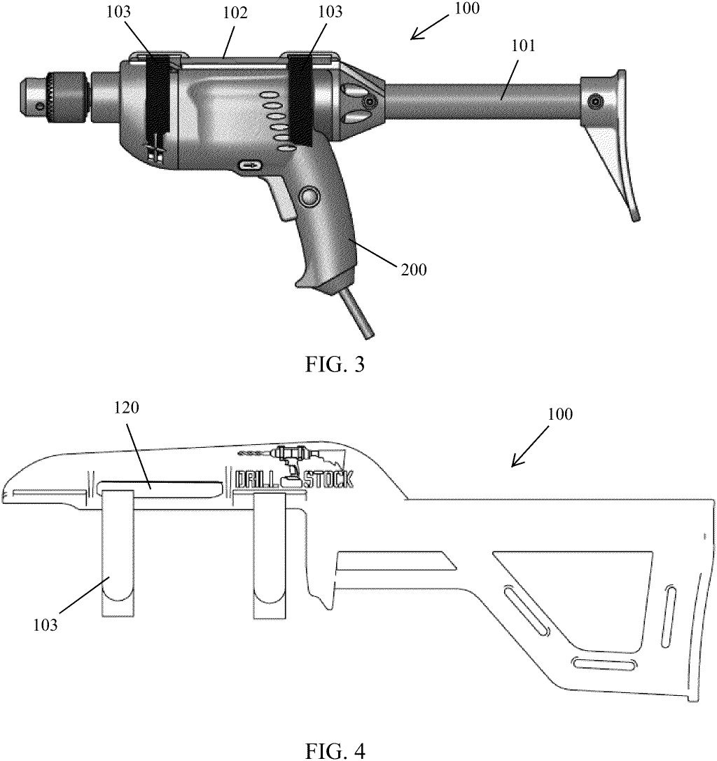

FIGS. 2A-2B show the adapter 100 fitted to a tool, with FIG. 2A showing the adapter 100 fitted to a battery-powered drill and FIG. 2B showing the adapter 100 fitted to a corded drill. As shown in these two examples, the stock 101 extends beyond the length of the tool 200 to allow the user to engage the tool in a comfortable position. FIG. 3 shows an alternative embodiment of the adapter 100 with an adjustable stock 101. In this particular example, the stock 101 comprises an aluminum tube (which can be cut to a desired length, replaced with a longer tube, etc.) and a shoulder rest 110.

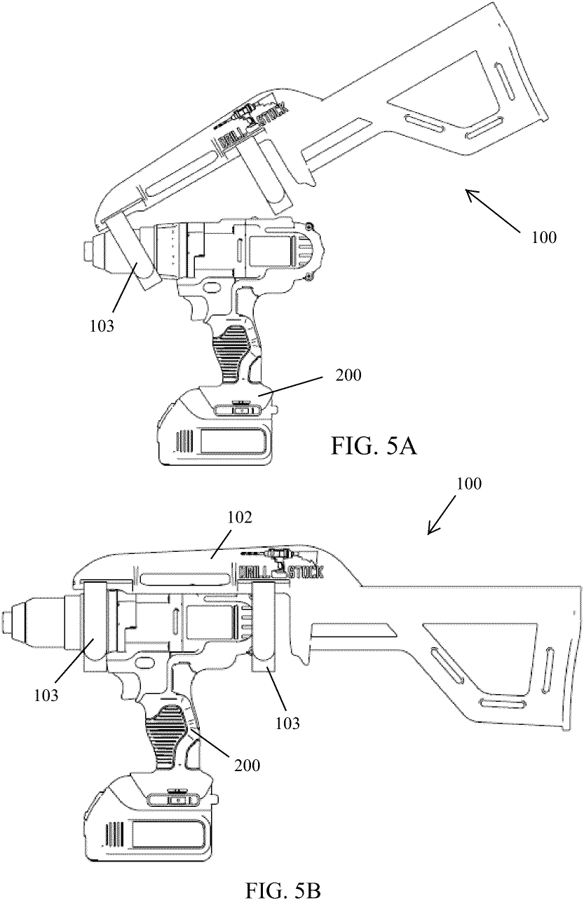

Referring again to FIGS. 2A-2B, the body 102 of the adapter 100 has a length substantially the length of the hand-held tool 200 to which it is fitted. The length of the body 102 should be sufficient to allow a front strap 103 to reach a suitable attachment point near the front of the hand-held tool 200 while a rear strap 103 is affixed near the rear of the tool 200. However, as shown in FIGS. 2A-2B, the strap retainer 120 permits a range of adjustment to accommodate tools 200 of varying length. In the example embodiment shown in FIG. 2A, the adapter 100 has an overall length of about 17 inches and the length of the body 102 is about 7 inches. The overall dimensions of the adapter 100 may vary based on the size of the user, the intended tool 200 on which the adapter 100 will be fitted, and the type of tool 200. To accommodate a variety of tool sizes, the strap can be moved to an alternative retainer slot 120, as shown in FIG. 4.

When affixed to the tool 200, the body 102 is positioned above the main body of the tool. Depending on the shape of the tool 200, the bottom surface of the body 102 may abut the top surface of the tool 200. In some embodiments, a small gap can be created between the body 102 and the tool 100 to permit access to the controls on the tool 200. As further shown in FIGS. 2A-2B, the rear of the body 102 cradles the rear of the tool 200. At the interface between the body 102 and the tool 200, rubber, foam, polymer, or similar materials can be disposed between the tool 200 and adapter 100 to provide cushioning and traction. During operation of the tool 200, a user will impart a force into the distal end of the stock 101, transferring the force into the tool 200 through the rear of the body 102 where it cradles the tool 200. Ultimately, the additional force imparted on the stock 101 will move through the tool 200 to the workpiece. For example, when the adapter 100 is fitted to a drill 200, the force imparted into the stock 101 will eventually move through the adapter 100 and tool 200 into the drill bit. In this configuration, the adapter permits a more comfortable and stabilized drilling operation.

FIGS. 2A-2B further show that the straps 103 are adapted to secure the body 102 of the adapter 100 to the tool 200. The straps 103 may be used to secure the body 102 tightly against the tool 200 depending on the shape and size of the tool 200. The straps 103 may be adjustable to fit a variety of different tools 200. In some embodiments, the straps 103 have sufficient adjustability to permit a single adapter 100 to be used with several different sizes of tools 200. The straps 103 may comprise hook-and-loop fasteners, belts, ratchets, buckled straps, rubber straps, band clamps, zip ties, or similar devices. In the embodiment shown in FIG. 2A, the straps 103 loop through a retainer 120 in the body 102 of the adapter 100 and encircle the tool 200. The straps 103 can provide lateral stability to the connection between the adapter 100 and the tool 200.

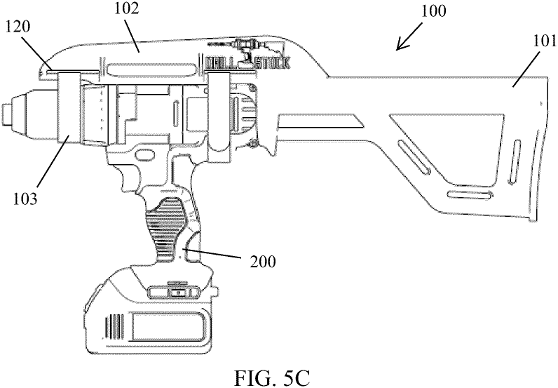

FIGS. 5A-5B show the adapter 100 in various stages of being fitted to the tool 200. In FIG. 5A, the front strap 103 is slid over the front of the tool 200 with the rear of the adapter 100 raised above the tool. At this stage, the strap 103 can remain loose to allow a greater range of movement between the adapter 100 and tool 200. FIG. 5B shows the rear of the adapter 100 near the rear of the tool 200, accomplished by moving the adapter 100 to a position parallel to the tool 200 and sliding the front strap 103 over the front of the tool 200. FIG. 5C shows the adapter 100 in the final position on the tool 200. In this step, the adapter 100 is slid forward onto the tool 200 to contact the rear of the body 102 against the rear of the tool 100. The straps 103 are then tightened to secure the adapter 100 to the tool 200.

The adapter 100 can be manufactured from a variety of materials, such as metal, composites, wood, plastic, or a combination of the foregoing. In one embodiment, the adapter 100 largely comprises a thermoplastic and is formed as a monolithic unit in an injection molding process to which straps 103 can be added.

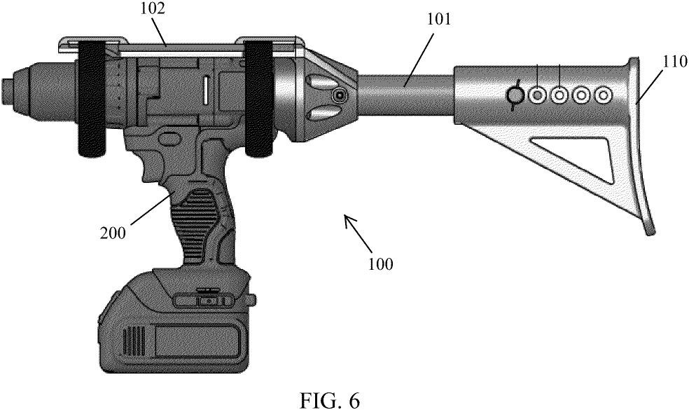

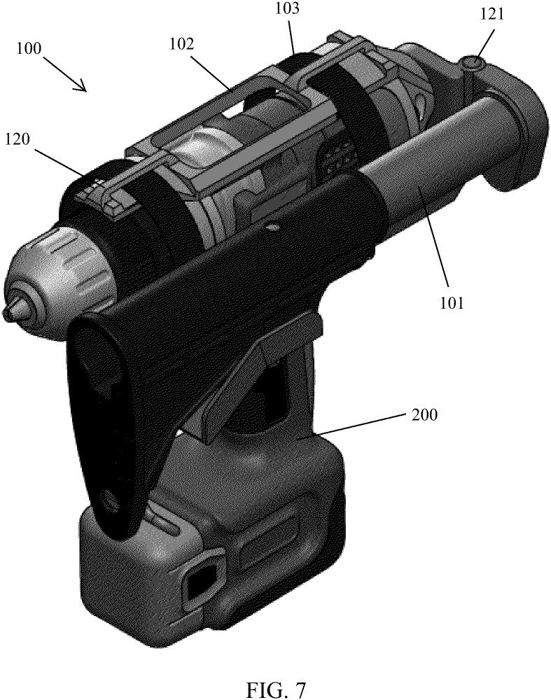

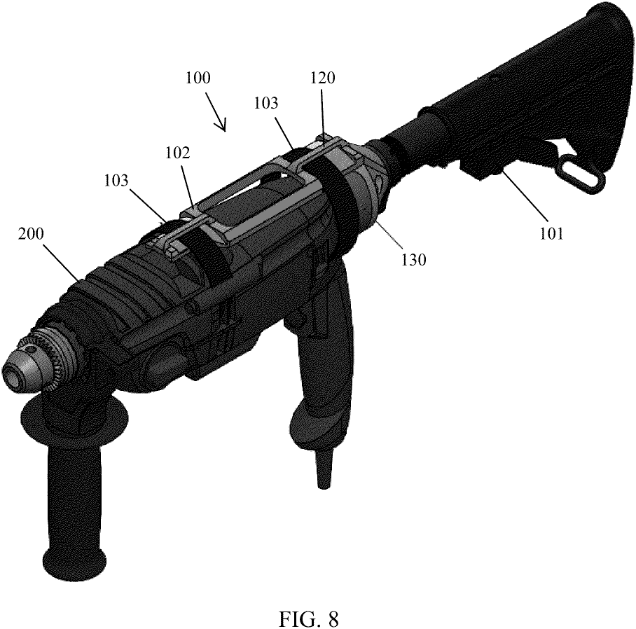

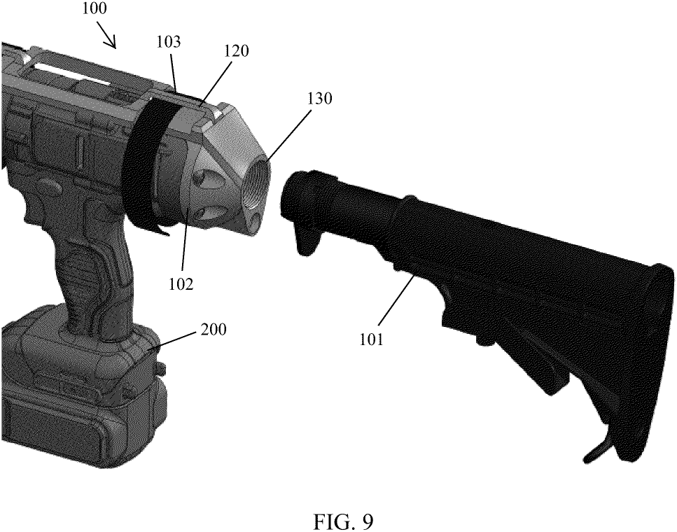

FIGS. 6-7 show alternative embodiments of the adapter 100. FIG. 6 shows an adapter 100 with an adjustable stock 101, where the stock 101 comprises a tube or extension piece with a series of spaced holes onto which a shoulder rest 110 engages via a pin. To extend the stock 101, the pin is removed and the shoulder rest 110 is slid along the tube and the pin reinserted into a hole at the desired position. FIG. 7 shows an embodiment where the stock 101 further comprises a hinge 121, which allows the stock 101 to fold, shortening the overall length of the adapter/tool combination. The folded position can be useful for storage or transportation. FIG. 8 shows yet another alternative embodiment where the adapter 100 comprises a body 102 and straps 103 with an interface 130 for connecting to a firearm stock 101. FIG. 8 shows an off-the-shelf stock 101 connected to the body 102 using a screw-type interface 130, using the standard threads present on the stock 101 and female threads on the adapter 100. FIG. 9 shows yet another alternative embodiment of the adapter 100 where the stock 101 is disconnected from the interface 130. For the embodiments shown in FIGS. 8-9, a user can purchase separately by a user and attached to the adapter 100.

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A tool adapter comprising:
a body adapted to abut a portion of a hand-held tool;
an extended stock connected to the body and having a length extending along a longitudinal axis of the body;
at least one strap connected to the body and configured to circumferentially engage the hand-held tool.

2. The tool adapter of claim 1, wherein a distal end of the extended stock is adapted to engage a shoulder of a tool user.

3. The tool adapter of claim 1, wherein the body further comprises a retainer through which the at least one strap passes.

4. The tool adapter of claim 3, wherein the retainer comprises a slot and the at least one strap is movable along a length of the slot.

5. The tool adapter of claim 1, wherein the at least one strap is removable.

6. The tool adapter of claim 1, wherein the extended stock further comprises a shoulder rest.

7. The tool adapter of claim 1, wherein the at least one strap is selected from the group consisting of a hook-and-loop fastener, a belt, a ratchet, a buckled strap, a rubber strap, a band clamps, and a zip tie.

8. The tool adapter of claim 1, wherein the extended stock comprises:
an extension having a series of holes;
a shoulder rest adapted to slidably engage the extension; and
a pin engaging at least one hole of the series of hole to affix the shoulder rest to the extension.

9. The tool adapter of claim 1, wherein the extended stock comprises:
a hinge connected to the body at a proximate end of the stock.

10. The tool adapter of claim 1, further comprising:
a material disposed on a rear portion of the body to provide traction between the body and the tool.

11. The tool adapter of claim 1, wherein the hand-held tool is selected from the group consisting of a drill, an impact driver, an impact wrench, a hammer drill, and a rotary hammer.

12. A tool adapter comprising:
a body adapted to abut a portion of a hand-held tool;
an interface adapted to connect to a removable gunstock;
at least one strap connected to the body and configured to circumferentially engage the hand-held tool.

13. The tool adapter of claim 12, wherein the interface comprises female threads.
